(19) United States
(12) Patent Application Publication
(10) Pub. No.: US 2018/0135594 A1
(43) Pub. Date: May 17, 2018

(54) Current Powered Generator Apparatus

(71) Applicant: David Mastel, Phelan, CA (US)

(72) Inventor: David Mastel, Phelan, CA (US)

(21) Appl. No.: 15/853,749

(22) Filed: Dec. 23, 2017

Related U.S. Application Data
(63) Continuation of application No. PCT/US16/39113, filed on Jun. 23, 2016.
(60) Provisional application No. 62/183,707, filed on Jun. 23, 2015.

(51) Int. Cl. F03D 5/04; F03B 13/22

(52) U.S. Cl. CPC F03D 5/04; F03B 13/22; F05B 2220/706; F05B 2210/16; F05B 2250/12; F05B 2280/1021; F05B 2280/6001; F05B 2240/31

(57) ABSTRACT

A frame which includes adjacent, spaced-apart segments that define adjacent, spaced-apart, and parallel closed-loop tracks supporting two or more articulated foils between the adjacent frame segments. Opposite distal ends of the foils cooperate with opposite tracks of the frame segments so that the foils can traverse along the tracks when current lifts the foils and pushes them along the tracks.

### CROSS-REFERENCE TO RELATED APPLICATION(S)

This application is a continuation of PCT Patent Application Serial No. PCT/US16/39113 filed on Jun. 23, 2016 entitled “Current Powered Generator Apparatus” The '113 application claimed priority benefits from Provisional Patent Application Ser. No. 62/183,707 filed on Jun. 23, 2015, entitled “Current Powered Generator Apparatus”. This application also claims priority benefits to the '707 application. The '707 and '113 applications are hereby incorporated by reference herein in their entireties.

### FIELD OF THE INVENTION

The present application relates to an apparatus for harvesting the energy in air or water currents to generate energy, such as mechanical and/or electrical energy. More particularly, the present application relates to an apparatus which utilizes solid and/or morphing foil(s) to take advantage of direct lift, rotational lift, centripetal lift and/or drag caused by the currents when generating energy.

Mankind has used various machines to harvest the power in air and water currents since ancient times. These prior devices have included horizontal as well as vertical shaft devices; they have included small as well as large numbers of blades; and they have included blades with many different shapes and sizes.

Within the last few hundred years electricity-generating wind turbines have appeared around the world. They include three primary types: a horizontal axis wind turbine typically equipped with three blades, a main rotor shaft and electrical generator mounted atop a tower; a vertical axis turbine with curved blades, a vertically oriented rotor shaft, and a generator near the ground; and a second vertical axis-type turbine similar to the first but with straight as opposed to curved blades.

While the prior wind turbines have achieved widespread use, they suffer a number of disadvantages, including less than optimal efficiency and higher cost of manufacturing per watt of power production than is desired. Horizontal axis turbines must point into the wind to even function, requiring wind sensors and servo motors to achieve proper orientation, the 360° longitudinal rotation of the airfoils around a center hub, and accordingly the higher dynamic loading on the blades.

Vertical axis turbines function better in variable wind conditions; but they suffer many of the disadvantages associated with the 360° longitudinal rotation of the airfoils around a center hub and accordingly the higher dynamic loading on the blades along with drag as the blade circles back into the wind past the center axis.

### SUMMARY OF THE INVENTION

The powered generator of the present disclosure avoids many of the disadvantages of prior propeller or turbines and provides consistent and reliable harvesting of power in a potentially wider variation of usable situations such as both lower and higher currents. Current is understood to include both wind and water currents.

The disclosed blades, sails and/or wings can utilize lift perpendicular to the rotational axis. Currently, much of the lift generated by wind currents is centripetally driven off the end of propellers. This causes vortex drag currents that reduce potential energy gains.

In some embodiments, lift is caused by the pressure differential between: (1) the low speed (high pressure) side of the foil and (2) the high speed (low pressure) side of the foil. Movement of the foil is caused by the high-pressure side moving toward the low pressure side. Foils can be configured to have a specific directional movement. During operation, a rotational aspect can be introduced into the air flow, resulting in energy loss. Energy loss can be centripetal in nature when the natural movement of the flow is forced outside of the circle defined by the foils. This in turn creates eddy currents that can have a drag effect on the foil.

The foil orientation can be configured such that the low-pressure side is in a position to utilize higher torque with less counterproductive portions. In these embodiments, the outer foil tip speeds are reduced and a lift with higher torque is captured with less centripetal stripping. The foil(s) can be larger because of lower tip speeds. In some embodiments, the foil(s) can change size depending on wind conditions.

It is important to note that drag coefficients are not always counter-productive. As drag increases lift may also increase. A properly configured foil can use drag to create useful productive rotational and/or linear forces while avoiding counter-productive forces.

The powered generator has a unique morphing foil design which maximizes efficiency of the generator. The foil produces power in one or more directions through lift and/or drag in both low and high velocity currents while minimizing, or at least reducing, scenarios where the foil would encounter no lift and encounter counter-productive drag. For example, in some embodiments the foil can go flat when moving against the current to reduce drag. The foil, which can also be referred to as a wing or sail, can be made of linked segments or a single segment.

In some embodiments, the foils have the ability to morph into a shape configured to utilize both changing wind speeds and pressures. This allows the generator to utilize both the lift away from the central shaft as well as rotational lift.

The power generator can function as both a horizontal and a vertical axis turbine. When the power generator is functioning as a vertical turbine, the foil can be essentially longitudinal and parallel to the rotational axis.

The apparatus of the present application converts current power into usable energy such as electrical energy. It includes a frame which has spaced-apart segments with each segment defining a closed-loop track. The tracks of adjacent segments are substantially co-extensive and lie in spaced-apart, parallel relation.

In some embodiments, the foils are attached to a single segment. In this embodiment the foil can have additional supports in addition to the track.

The apparatus can also include a plurality of foils substantially spaced between the adjacent frame segments, with one distal end of each foil cooperating with the track of one segment and the opposite distal end of the foil cooperating with the track of the adjacent segment. In some embodiments, the foils are aligned perpendicular to the frame segments similar to a carousal. In other embodiments, the foils are not aligned parallel to the frame segments.

In some embodiments, each foil includes a plurality of segments pivotally connected in end-to-end relationships. The foils are adapted to traverse the adjacent closed-loop tracks in response to current force applied to the foils to push and/or lift them along the tracks. These tracks can be present on one or both of the segments.

In some embodiments, the tracks are trough-like and create a generally triangular loop. In another embodiment the trough is a hexagonal loop. In other embodiments, the tracks are simply linear or curved tracks in which the foil moves back and forth.

The distal ends of each foil member can have one or more rollers secured to the rest of the foil. In some embodiments, these rollers are fixed, in other embodiments, they are removable. The rollers extend into the trough-like track and roll in the longitudinal direction of the tracks allowing the foils to traverse the tracks. In some embodiments, rollers are only used on one end of the foil. In other embodiments, rollers are used on both ends of the foils.

In certain embodiments, the apparatus is configured to periodically discharge static electricity to help maintain the integrity of its components.

### BRIEF DESCRIPTION OF THE DRAWINGS

FIG. 1 is a perspective view of a current powered generator.

FIG. 2 is a plan view of a current powered generator.

FIG. 3 is a front elevation view of a generator.

FIG. 4 is an exploded view showing the connection between a foil and a track of a generator.

FIG. 5 is a plan view of one of the foils of the generator, showing the foil member in three different positions.

FIG. 6 is a plan view of one of the tracks of the generator.

FIG. 7 is a plan view of the tracks and generator assembly.

FIG. 8 is a plan view of an alternative foil arrangement, with two members disposed on one platform rather than the one member arrangement of FIG. 5.

FIG. 9 is a plan view of an alternative roller arrangement used on the bottom and top distal ends of a foil to engage the track and allow the foil to roll along the track.

FIG. 10 is a front elevation view of the foils and the roller arrangement of FIG. 9.

FIG. 11 is a plan view of another alternative foil and platform arrangement that includes pairs of platforms connected with connecting rods, with each platform supporting two foils.

FIG. 12 is a front elevation of the arrangement of FIG. 11.

FIG. 13 is an exploded view of the assembly shown in FIGS. 11 and 12.

FIG. 14 is a front elevation view of a second embodiment of a generator.

FIG. 14A is a cutaway perspective view of the piston-like support of the generator shown in FIG. 14.

FIG. 15 is a sectional view taken along line A-A in FIG. 14.

FIG. 16 is a front elevation view of an alternative of the second embodiment of FIG. 14.

FIG. 16A is a cutaway perspective view of the piston-like support of the generator shown in FIG. 16.

FIG. 17 is a sectional view taken along line B-B in FIG. 16.

### DETAILED DESCRIPTION OF EMBODIMENT(S)

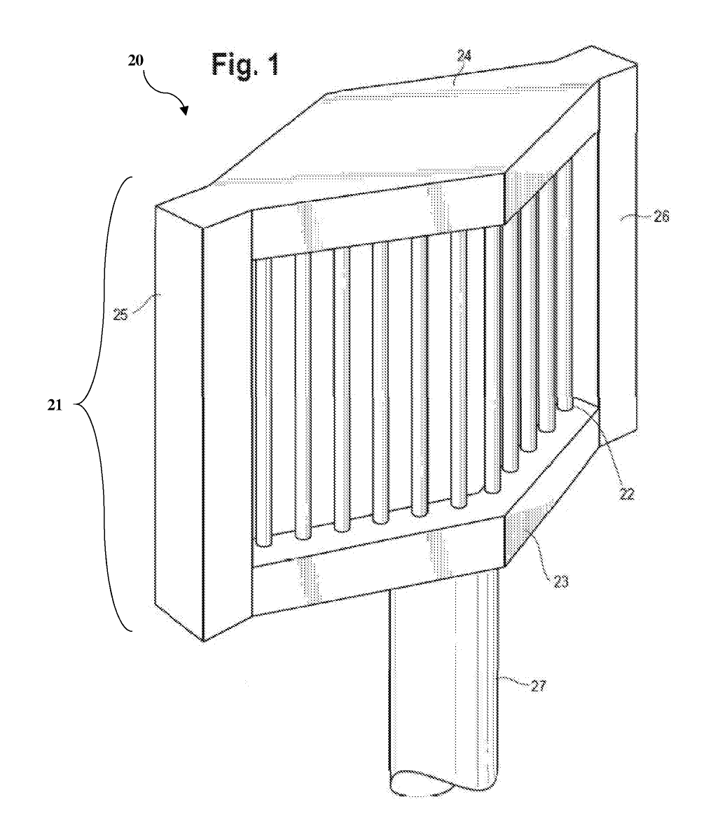

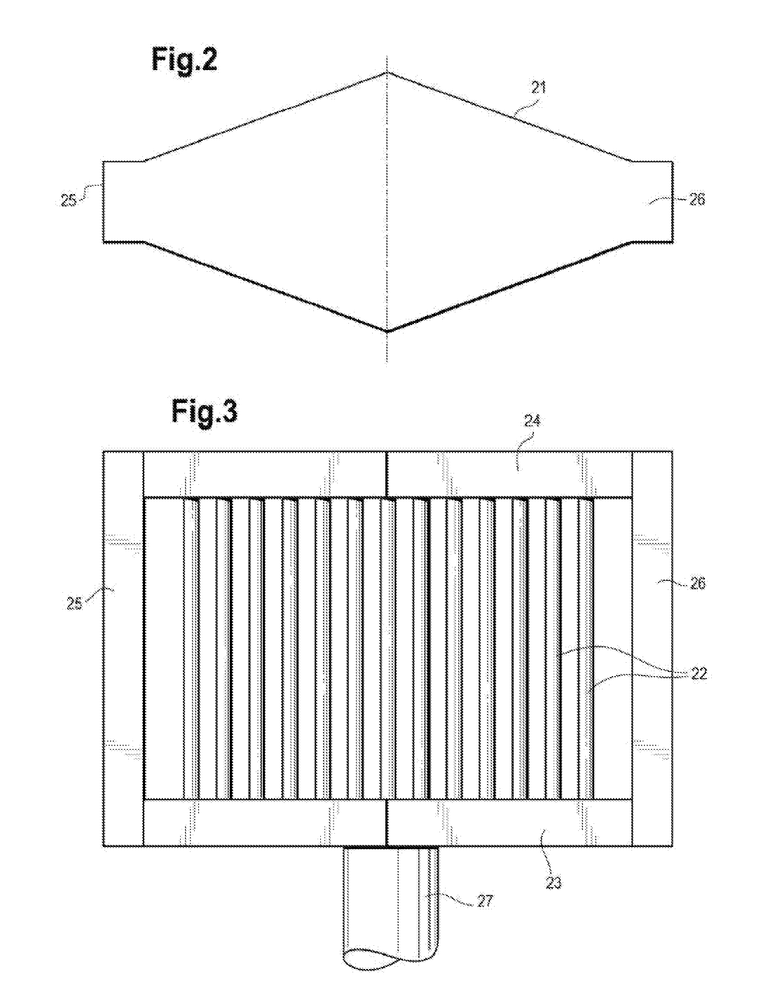

Current powered generator 20 (see FIGS. 1-3) generally includes frame 21 and moveable foils 22 disposed vertically and spaced apart a predetermined distance. Frame member 21 includes bottom segment 23, opposite top segment 24 and opposite column segments 25 and 26 that connect segment 23 and segment 24 a predetermined distance apart. Frame 21 can lie on the ground or alternatively a predetermined distance above the ground atop supporting base 27 to form a tower. A material of high strength and rigidity can form frame 21.

In the embodiment shown, each foil 22 includes four segments 28, 29, 30 and 31 which are elongated, vertical and plate-like pieces pivotally connected in edge-to-edge (i.e. end-to-end) relation to form an articulated air foil. In other embodiments, the foils can be made of various numbers of segments, or made of a single piece. The foils function like the wings of an airplane or the sails of a water vessel to lift the foil, or in this case to push it along its predetermined path. In at least some embodiments, each segment 28-31 includes a frame and a shell made of sheet aluminum, cotton canvas, carbon-fiber or other suitable materials. Although the embodiments and alternatives shown in the drawings include foils with four segments, the foils can alternatively include fewer segments or a greater number of segments.

In certain embodiments, the segments of the foil are pivotally connected in end-to-end relations to create different lift/drag combinations that can be configured to particular situations.

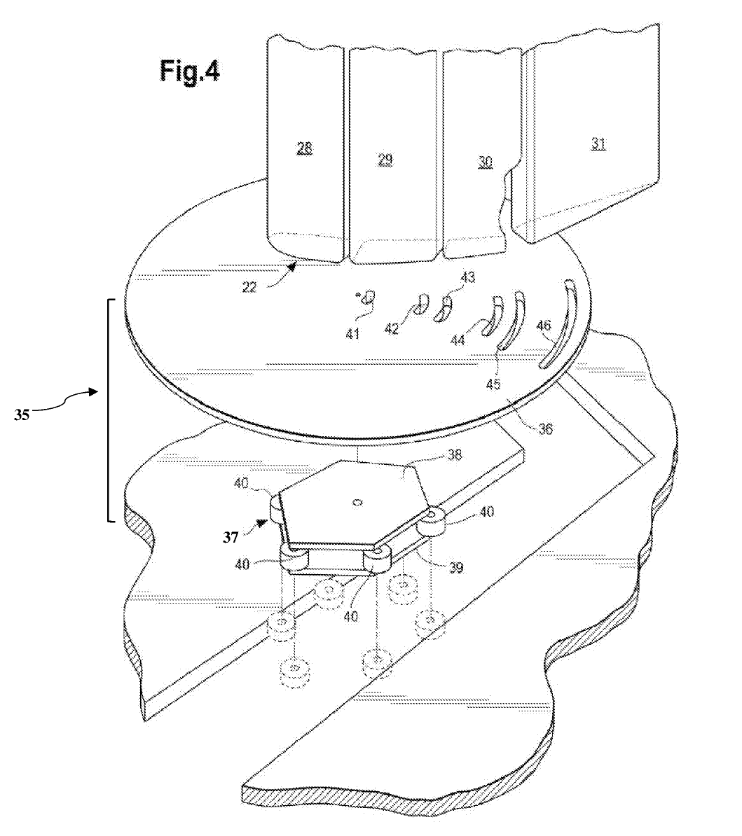

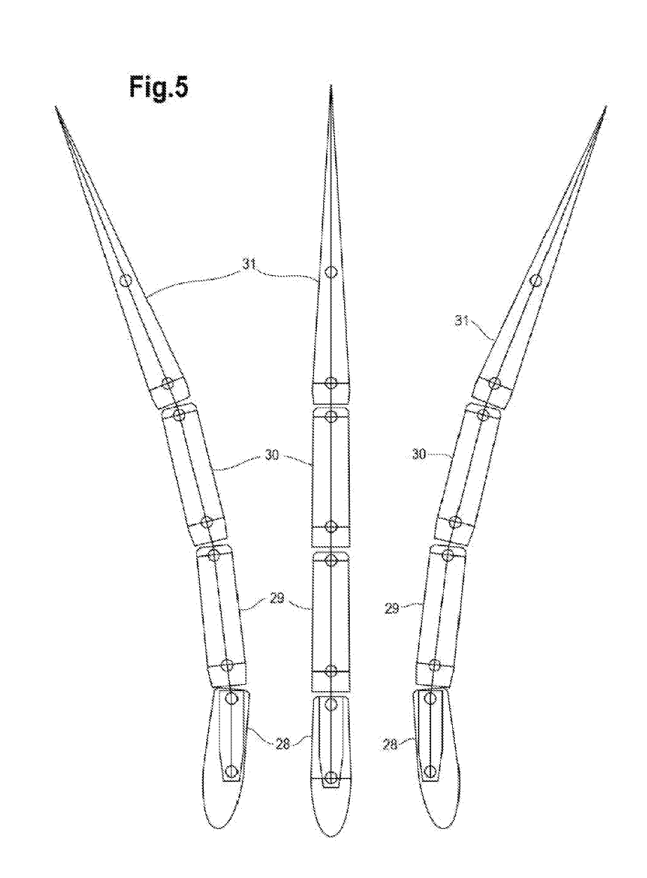

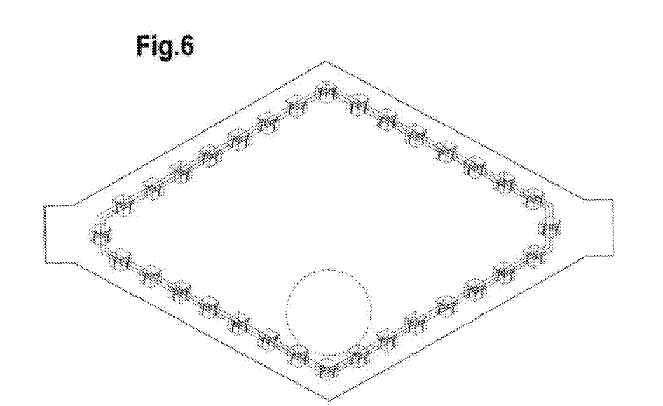

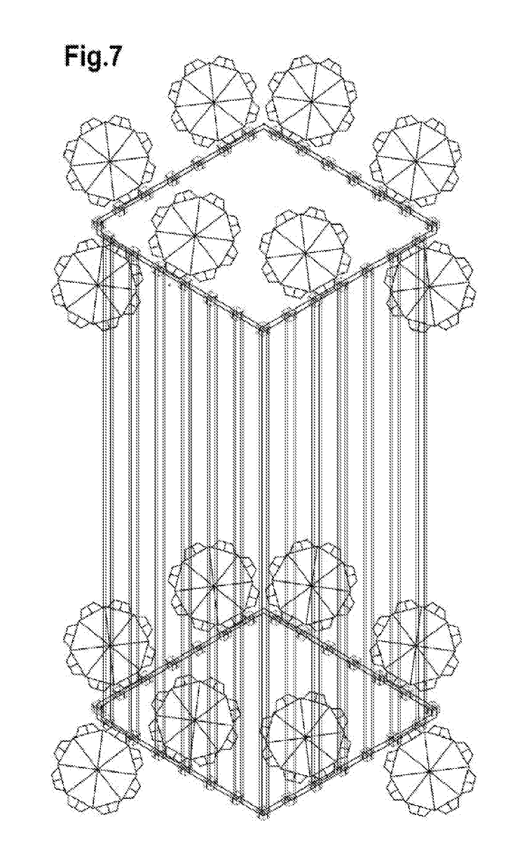

Both top segment 24 and bottom segment 23 of frame 21, define a closed-loop track. As shown in FIGS. 4 and 7, the track of each segment 23 and 24 is a channel. In the embodiment of FIGS. 1-8, the track has an overall diamond-like shape. Tracks of opposite and adjacent segments 23 and 24 are substantially co-extensive and lie disposed in spaced-apart, generally parallel relation. They guide foils 22 along the predetermined diamond path in generator 20 in response to the current which pushes the foils, longitudinally along the path. Foil orientation (morphing) is used to both create productive lift and/or drag (that is lift and/or drag that generates more energy) and/or to reduce counterproductive lift and/or drag. In some embodiments, the foils are configured to receive lift and/or drag in multiple directions.

In the shown embodiment, platform unit 35 connects each distal end of foil 22 with either frame segment 23 or frame segment 24. Unit 35 includes plate 36 and roller assembly 37 with hexagonal and spaced-apart plates 38 and 39 and rollers 40 disposed between plate 38 and plate 39, rotatably mounted to them. Plate 36 lies secured to plate 38 (as with welding, nut and bolt, or similar connections) at one face and to a distal end of a foil at the opposite face. In some embodiments, only foil segment 28 is fixedly secured (e.g. with nut and bolt connections) to plate 36. The other three segments 29-31 can move with respect to plate 36. In some embodiments the other three segment 29-31 can only move a predetermined extent. Slot 41 and slot 42 define the limits of segment 29 pivot; slot 43 and slot 44 define the limits of segment 30 pivot; and slot 45 and slot 46 define the limits of segment 31 pivot. Thus, foils 22 can assume the position that allows the most lift and push provided by current movement through generator 20.

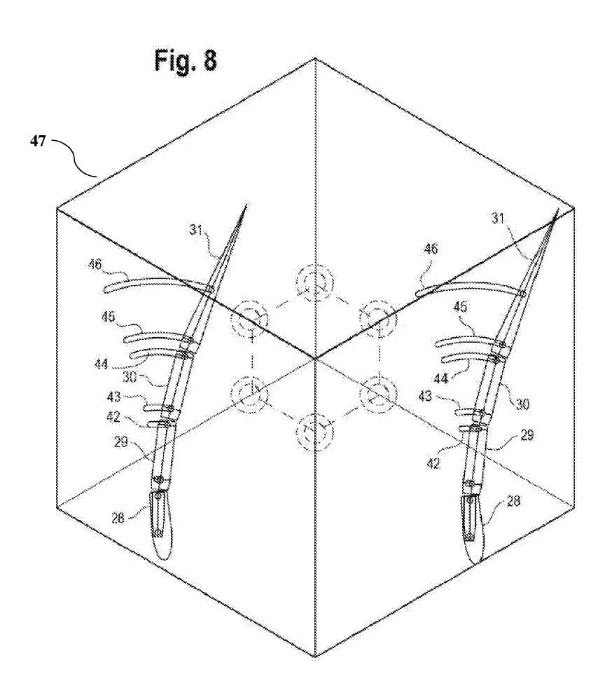

Although the embodiment described above has foils 22 oriented vertically, a horizontal orientation of the foils allows the apparatus to function in the same manner to produce essentially the same results as a vertical foil unit. In some embodiments, platform units 35 can be modified to mount a pair of foils 22 to frame segment 23 and frame segment 24, as shown in FIG. 8. In this modification, a second plate provides the same function as plate 36. In addition, either hexagonal plate 38 and/or another hexagonal plate cooperate with plates of generator 20 disposed along the path of tracks to drive plates and generate electrical energy.

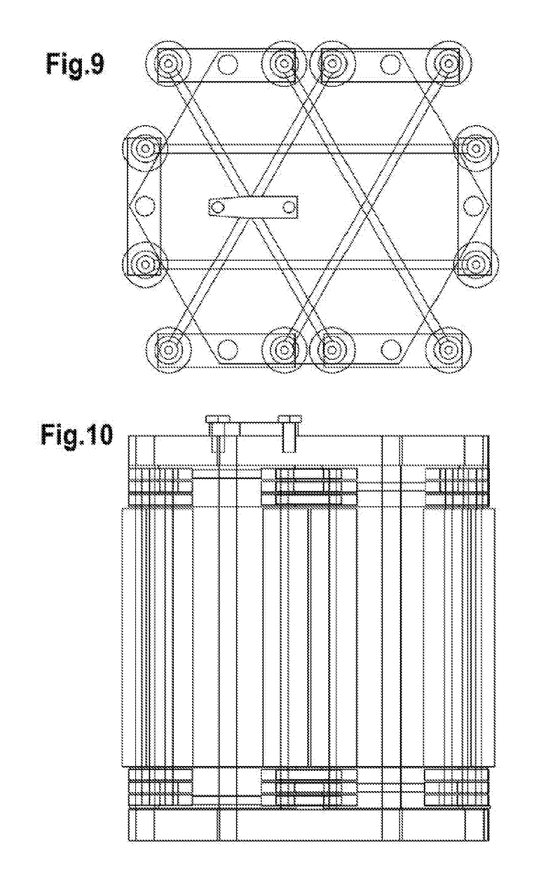

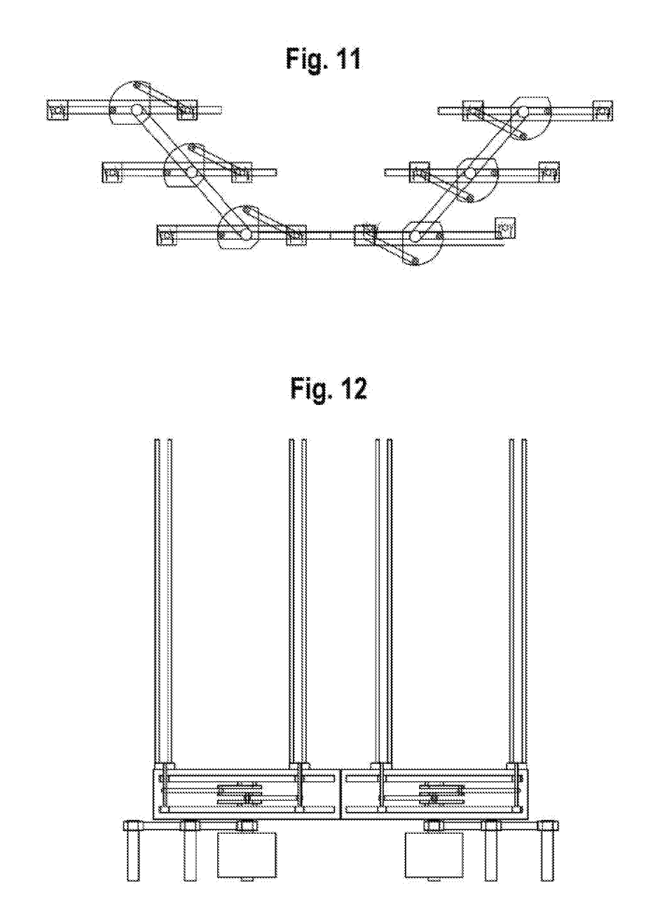

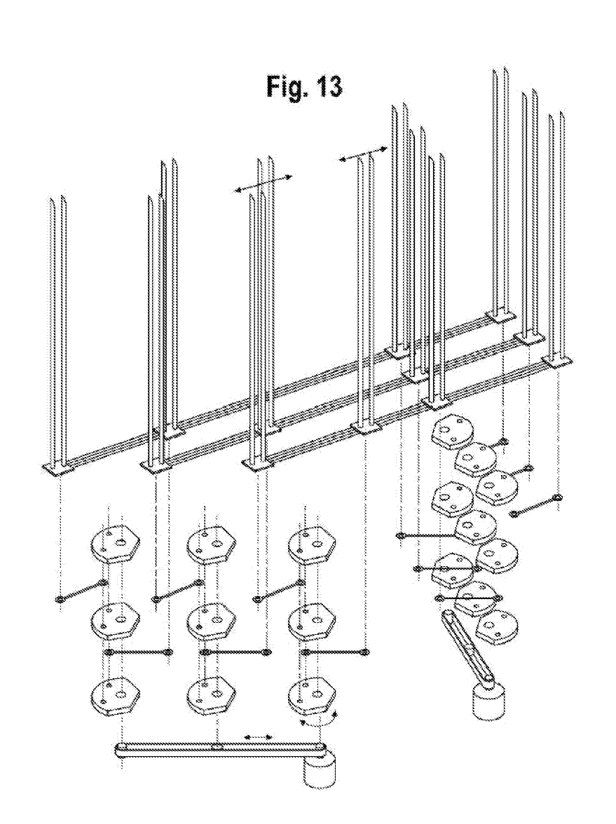

FIGS. 9 and 10 show a modified roller assembly, while FIGS. 11 to 13 show a modified assembly for connecting the platform units of one foil 22 to adjacent member 22. In the embodiment and modifications shown in FIGS. 1-10 connecting rods and/or a bicycle-type chain are used to connect the foils together. In some embodiments, the foils are spaced predetermined distance apart.

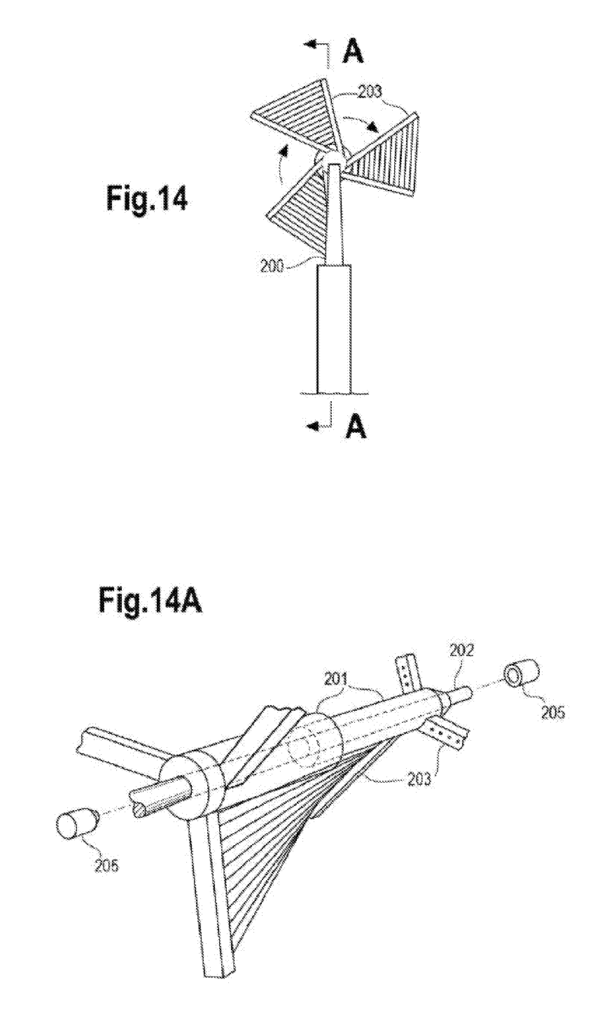

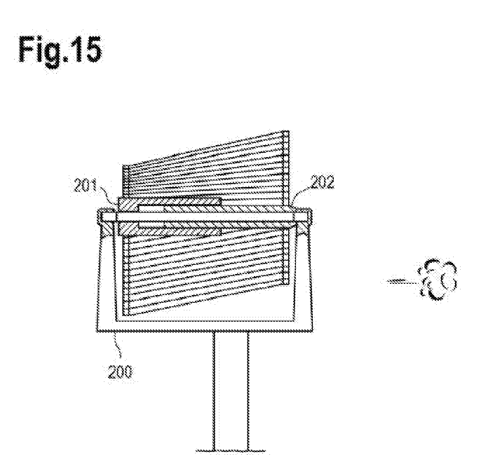

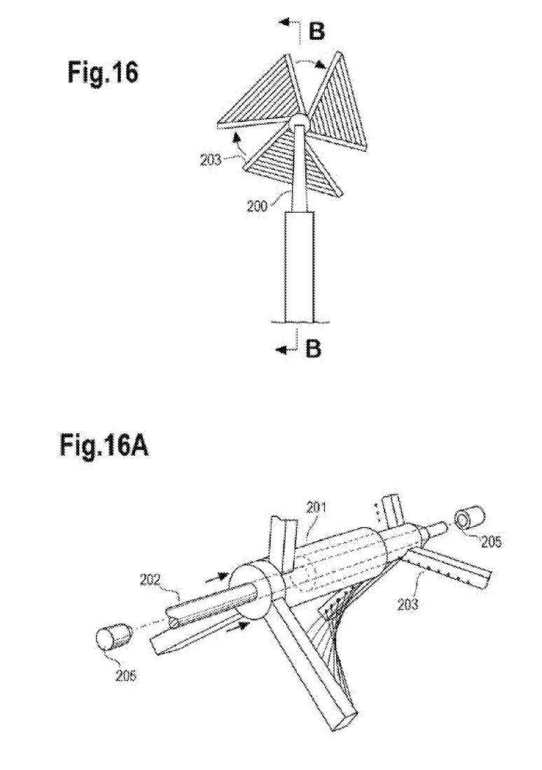

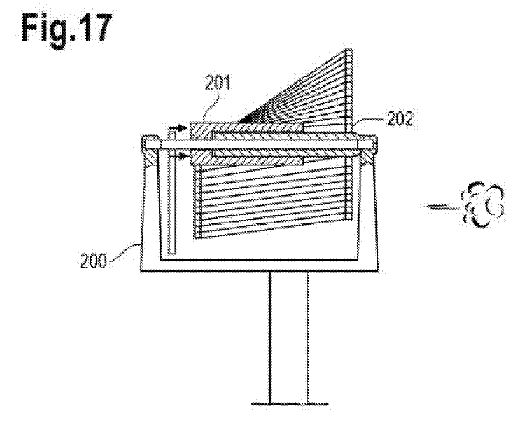

FIGS. 14 to 17 show a second embodiment of a current powered generator. This embodiment includes frame 200 with piston-like support 201 rotatably mounted to frame 200 by axle 202. It also includes three foil members secured at opposite ends of piston-like support 201 with foil member supports 203. This embodiment produces energy as a result of the rotation of the foil members along axle 202 as well as the in and out movement of piston-like support 201 caused by variable current pressure on the foils. Bearing 205 is used in connection with axle 202.

In some embodiments, the use of two conventional rods with an additional wishbone rod for the connection of a third foil mechanism allows the harvesting of power similar to a three-phase electric motor. Two of the rods are at a high torque input position when the other foil can morph into a configuration for harvesting the power of the current in the opposite direction.

In some embodiments, the morphing foil moves from a spinnaker configuration in low winds to a flattened and taut foil in high winds. In some embodiments, this morphing is controlled by rotational springs which can be activated by moment arm pressures as current speeds and lift are increased. In this way the morphing foil can be self-regulating.

The rod harvests power in both movements of the stroke. In some embodiments, this is accomplished with a single rod crankshaft per unit, timed with additional complete units, linked with timing belts and/or other acceptable alternatives and rotationally sequenced in any combination that might be rotationally significant to the power conversion method chosen.

In traditional blades, sails or wings that utilize lift perpendicular to the axis, much of the lift is centripetally driven off the end of the propellers. This causes vortex drag currents that reduce potential energy gains. It is beneficial if the lift is vectorially accumulative between rotational movements and natural centripetal flow and centripetal lift from a rotating device where lift controls outward flow.

In some embodiments, this can be accomplished by making the axis either arc from the perpendicular starting point of the blade or by immediately rotating the blade at the axis to make acute portions for lift and obtuse portions for low pressure where the lift presses toward.

In some embodiments, by slowing the rotational movement and harvesting energy at lower rotating speeds, energy losses can be reduced.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An apparatus that converts current power into usable energy, the apparatus comprising:
a. a frame which includes a first segment, wherein said first segment includes a first track; and
b. a foil, wherein a distal end of said foil is configured to be placed in said track of said first segment.

2. The apparatus of claim 1 wherein said foil comprises:
i. a first foil segment; and
ii. a second foil segment, wherein said first foil segment and said second foil segment are pivotally connected.

3. The apparatus of claim 2 wherein said foil is configured to adjust to a current.

4. The apparatus of claim 3 wherein said current is a wind current.

5. The apparatus of claim 3 wherein said current is a water current.

6. The apparatus of claim 1 further comprising:
c. a second segment.

7. The apparatus of claim 6 wherein said second segment has a second track.

8. The apparatus of claim 1 wherein said track is linear.

9. The apparatus of claim 1 wherein said track is a loop.

10. The apparatus of claim 7 wherein said first track and said second track are essentially perpendicularly aligned.

11. The apparatus of claim 2 wherein said foil is made of canvas.

12. The apparatus of claim 2 wherein said foil is made of sheet aluminum.

13. The apparatus of claim 1 wherein said frame is placed on a base.

14. The apparatus of claim 1 wherein said frame is configured to be placed at ground level.

15. The apparatus of claim 1 wherein said foil comprises:
i. a first foil segment;
ii. a second foil segment;
iii. a third foil segment; and
iv. a forth foil segment.

16. The apparatus of claim 1 wherein said track is a diamond-shaped.

17. The apparatus of claim 2 further comprising:
c. a platform unit configured to connect said foil to said frame segment.

18. The apparatus of claim 17 wherein said platform unit comprises:
i. a plate; and
ii. a roller assembly.
